(19) United States
(12) Patent Application Publication
(10) Pub. No.: US 2013/0332114 A1
(43) Pub. Date: Dec. 12, 2013

(54) Systems and Methods for Commissioning a Sensor

(71) Applicant: Utah State University Research Foundation, North Logan, UT (US)

(72) Inventors: Aravind Raghavendra Dasu, Herndon, VA (US); Ran Chang, Logan, UT (US); Matt Cupal, Logan, UT (US)

(21) Appl. No.: 13/915,450

(22) Filed: Jun. 11, 2013

Related U.S. Application Data
(60) Provisional application No. 61/658,291, filed on Jun. 11, 2012.

(51) Int. Cl. G01D 21/00

(52) U.S. Cl. CPC G01D 21/00
USPC 702/189

(57) ABSTRACT

A computer implement method for commissioning a sensor is described. The method includes monitoring for a commissioning event. Upon detection of the commissioning event, a switch is paired with a sensor. A doorway that is in a field of view of the sensor is identified. A boundary that separates a doorway area from a neighboring area that is in the field of view of the sensor is also identified.

### STATEMENT REGARDING FEDERALLY SPONSORED RESEARCH/DEVELOPMENT

The present application claims priority to U.S. Provisional Patent Application 61/658,291, filed Jun. 11, 2012, which is incorporated by reference in its entirety.

### STATEMENT REGARDING FEDERALLY SPONSORED RESEARCH/DEVELOPMENT

This invention was made with government support under Grant Numbers EE-003114 and 10085901 awarded by the U.S. Department of Energy. The government has certain rights in the invention.

### BACKGROUND

In various situations, motion and/or occupancy of individuals in a room may be detected for various reasons. For example, the lighting and/or climate controls may be altered based on occupancy and/or the motion in the room. Altering the lighting, climate, etc. based on the motion and/or occupancy of a room by individuals may reduce energy costs.

While motion and/or occupancy sensors may provide certain benefits and efficiencies, the cost of installing a sensor system may limit its adoption and use. In particular, commissioning a sensor system is often an expensive and laborious process.

### SUMMARY

A computer implemented method for commissioning a sensor is described. The method includes monitoring for a commissioning event. Upon detection of the commissioning event, the method also includes pairing a switch with a sensor. The method additionally includes identifying a doorway that is in a field of view of the sensor. The method further includes identifying a boundary that separates a doorway area from a neighboring area that is in the field of view of the sensor.

A computer implemented method for pairing a switch with a sensor is also described. The method includes monitoring for a synchronization event. Upon detection of the synchronization event, the method also includes determining a commissioning order. The method additionally includes monitoring for a commissioning turn based on the commissioning order. Upon detection of the commissioning turn, the method further includes pairing a switch with a sensor.

A computer implemented method for building a sensor relationship is also described. The method includes obtaining a commissioning indication. The method also includes detecting an exit indication from a first sensor. The method additionally includes detecting an entrance indication from a second sensor. The method further includes determining if a time between the exit indication and the entrance indication satisfies a predetermined threshold, and if the time satisfies the predetermined threshold, then building a relationship between the first sensor and the second sensor.

A computer implemented method for determining a doorway boundary is also described. The method includes obtaining a location of a doorway. The method also includes monitoring the doorway for a first commissioning pattern. The method additionally includes determining a first doorway boundary based on the first commissioning pattern.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a commissioning module;

FIG. 3 is a block diagram illustrating one example of a news broadcast;

FIG. 4 is a block diagram illustrating one embodiment of a building in which the systems and methods described herein may be implemented;

FIG. 5 is a block diagram illustrating one example of a field of view that may be associated with a room;

FIG. 6 is a block diagram illustrating one example of a doorway training process for a doorway in a field of view;

FIG. 7 is a block diagram illustrating another example of the doorway training process for a doorway in a field of view;

FIG. 8 is a block diagram illustrating another example of the doorway training process for a doorway in a field of view;

FIG. 9 is a block diagram illustrating another example of the doorway training process for a doorway in a field of view;

FIG. 10 is a block diagram illustrating one example of a field of view following the commissioning process;

FIG. 11 is a flow diagram illustrating one example of a method for commissioning a sensor;

FIG. 12 is a flow diagram illustrating one example of a method for pairing a switch with a sensor;

FIG. 13 is a flow diagram illustrating another example of a method for pairing a switch with a sensor;

FIG. 14 is a flow diagram illustrating one example of a method for building a topology map of the sensors;

FIG. 15 is a flow diagram illustrating one example of a method for building relationships between sensors;

FIG. 16 is a flow diagram illustrating one example of a method for training a doorway boundary;

FIG. 17 is a flow diagram illustrating another example of a method for training a doorway boundary; and

FIG. 18 depicts a block diagram of an electronic device suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

When a building is fitted with a plurality of occupancy sensors and switches, it may be desirable to have an automated pairing process for pairing the switches with their appropriate sensor. Additionally or alternatively, it may be desirable to enable the plurality of sensors to be aware of each other's geospatial location relative to each other. Additionally or alternatively, it may be desirable to identify the precise boundaries of a doorway. Furthermore, it may be desirable to perform each of these processes in a simple and low cost way.

In some configurations, the systems and methods described herein may be used to automatically pair a switch with a sensor. For example, the systems and methods described herein may enable a switch to be matched with the sensor that corresponds to the switch's lighting areas.

In some configurations, the systems and methods described herein may be used to identify the locations of doorways in a field of view. For example, each sensor may observe the motion behavior pattern of a person who may be commissioning the sensors (system). In some configurations, a person may commission the system by walking from door to door in a specific manner. In some cases, the specific manner may include walking throughout open areas and/or walking past or around a door. In some configurations, the person may act as the controller for the system. In some configurations, each sensor may automatically communicate coordinate data with neighboring sensors to establish a topology of relationships. In some configurations, the location of the doorways may be obtained by each sensor.

In some configurations, the systems and methods described herein may automatically perform on-board real time processing using image pattern recognition to identify doorway boundaries. For example, the doorways and/or doorway boundaries may be identified with minimal involvement from humans to visually inspect and annotate doorways.

Pairing a Switch to a Sensor

In some configurations, the systems and methods described herein may be used to pair a switch with a sensor. For example, each sensor may perform local observation to determine the brightness change associated with various switches being cycled on and off. The sensor may identify the switch that provides the maximum brightness change and may pair the switch associated with the maximum brightness change with the sensor.

Relationship Table Construction

In some configurations, the sensor's relationship table construction and doorway area training may be used to obtain a topology of sensors. For example, the topology of sensors may associate neighboring sensors with their unique identifiers and any possible shared common doorway areas. In some configurations, the commissioning process may equip each sensor with a complete relationship table for the entire sensor system.

In some configurations, each sensor may be running an algorithm to learn the topology among itself and its neighbors. A trainer may walk through every doorway (e.g., that are covered by the sensor system). In some configurations, this may enable every sensor to build a complete relationship table. For example, the algorithm may detect the trainer's presence (e.g., when the trainer enters and leaves the room) and broadcast corresponding news on the news channel according to the status of the trainer's presence and absence in the room. In some configurations, each sensor may intercept any news that is being broadcasted on the news channel and capture the useful news for building the relationship table.

Doorway Training

In some configurations, the doorway training process may use an unoccupied room with acceptable lighting conditions. In some cases, multiple doorways in a room may be trained sequentially. In the case of training an exit to an external room (e.g., an exit to the outside), the trainer may initialize the training by entering through the doorway to be trained (to be in full view of the sensor) and then exiting through the doorway to be trained until the trainer is outside the view of the sensor. In the case of training an exit to an internal room, the trainer may initialize the training by entering through any door (coming in full view of the sensor) and then exiting through the doorway to be trained until the trainer is outside the view of the sensor. In some configurations, the training process includes performing a first commissioning pattern, exiting from the field of view of the sensor, and performing a second commissioning pattern. In some cases, the sensor may use the trainer's body as a controller for commissioning the doorway. For example, the first commissioning pattern and/or the second commissioning pattern may be performed using the trainer's body. In one example, the trainer may repeatedly walk in and out of the door to indicate that the trainer's body is to be used as a controller. In some cases, a device that transmits a signal to the sensor may be used for commissioning a doorway. For example, the device may be used to send a signal that the trainer is standing just inside or just outside the doorway.

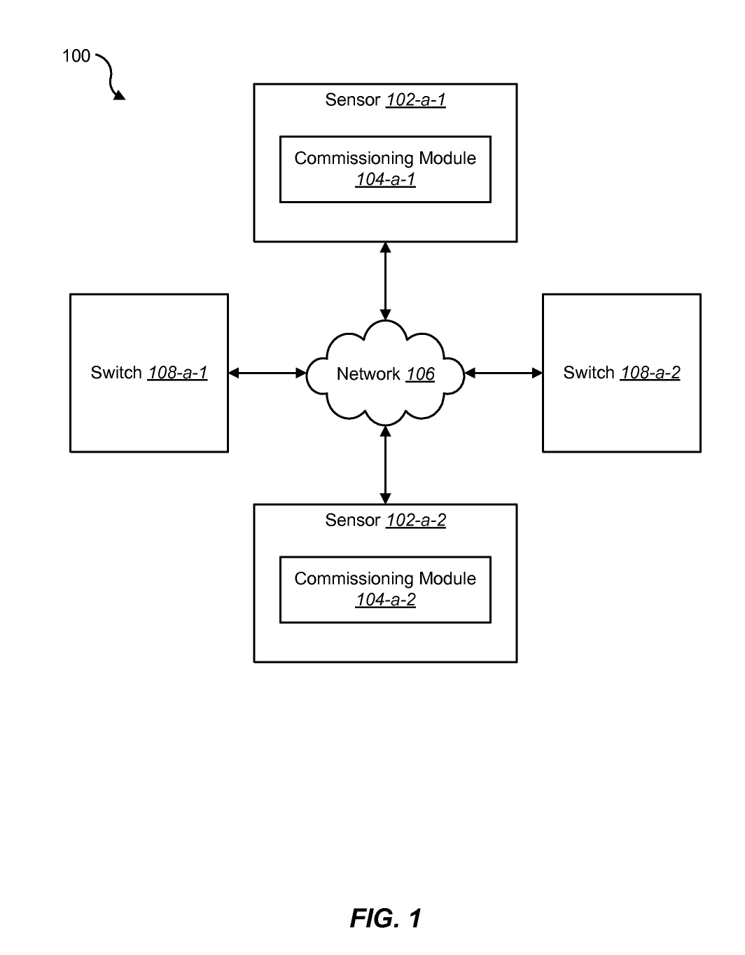

Referring now to the figures, FIG. 1 is a block diagram illustrating one embodiment of an environment 100 in which the present systems and methods may be implemented. In some configurations, the environment 100 may include one or more sensors 102 and one or more switches 108. For example, the sensors 102 may include a first sensor 102-a-1 and a second sensor 102-a-2 and the switches 108 may include a first switch 108-a-1 and a second switch 108-a-2. In one embodiment, the sensors 102 and/or the switches 108 may be communicatively coupled together through a network 106. Examples of the network 106 include wired networks (e.g., networks over existing wiring, networks over installed wiring, etc.) and/or wireless networks (e.g., ZigBee, Wi-Fi, Bluetooth, radio frequency networks, etc.).

In some embodiments, the sensor 102 may include an image sensor, a microprocessor, and a wireless radio chipset. In some configurations, the imaging sensor may include an array of pixel sensors that convert light information into electrical signals (e.g., image data). In some configurations, the microprocessor may process the image data from the image sensor. For example, the microprocessor may process the image data using intelligent algorithms for occupant detection and/or sensor commissioning. In some configurations, the wireless radio chipset may be used to communicate over the network 106.

In some embodiments, each sensor 102 may include a commissioning module 104. For example, the first sensor 102-a-1 may include a first commissioning module 104-a-1 and the second sensor 102-a-2 may include a second commissioning module 104-a-2.

In some configurations, the commissioning module 104 may be used to pair a switch 108 with a sensor 102. For example, the first commissioning module 104-a-1 may be used to pair the first switch 108-a-1 with the first sensor 102-a-1. Similarly, the second commissioning module 104-a-2 may be used to pair the second switch 108-a-2 with the second sensor 102-a-2. In one embodiment, a plurality of switches 108 may be paired with a single sensor 102. In another embodiment, a single switch 108 may be paired with a plurality of sensors 102.

In some configurations, the commissioning module 104 may be used to determine the geospatial location of a sensor 102 with respect to another sensor 102. For example, the first commissioning module 104-a-1 may determine that a doorway that is in the field of view of the first sensor 102-a-1 leads to a doorway that is in the field of view of the second sensor 102-a-2. Thus, the first commissioning module 104-a-1 may determine that the first sensor 102-a-1 and the second sensor 102-a-2 are neighbors via a specific doorway. In another example, the first commissioning module 104-a-1 may determine that an open area in the field of view of the first sensor 102-a-1 corresponds to an open area that is in the field of view of the second sensor 102-a-2 (where multiple sensors 102 are covering various portions of a single large room, for example). In some embodiments, the first commissioning module 104-a-1 may store this information in a first relationship table. Additionally, the second commissioning module 104-a-2 may determine that the second sensor 102-a-2 and the first sensor 102-a-1 are neighbors via a specific doorway. In some embodiments, the second commissioning module 104-a-2 may store this information in a second relationship table. In some configurations, each commissioning module 104 may generate a relationship table that identifies relationships between each of the sensors 102.

In some configurations, the relationship table may be transmitted to a server that collects and coordinates the various relationship tables into a master table. In some cases, the master table may be transmitted back out and received by the commissioning module 104. In some examples, that master table may include spatial information, location of doorways, etc. In some cases, some or the entire master table may be manually overridden by a trainer and/or building manager (to adjust spatial relationships, for example). In some embodiments, the commissioning module 104 may generate a topological mapping of the sensors 102 based on the relationships between the sensors 102 (using the relationship table and/or the master table, for example). In another embodiment, the topological mapping of the sensor 102 may be generated by the server and received by the sensors 102. In one example, the topological mapping may indicate the set of neighbor relationships between the sensors 102.

In some configurations, the commissioning module 104 may be used to identify the precise boundaries of each doorway that is in the field of view of the sensor 102. For example, the commissioning module 104 may identify the specific boundaries of a doorway to enable activity outside of the doorway area to be ignored. Additionally or alternatively, the commissioning module 104 may be used to identify the specific boundaries of a window. For example, the commissioning module 104 may use changes in external light to automatically identify and/or detect a window. Additionally or alternatively, the commissioning module 104 may be used to identify relationships between sensors 102 that are located in open areas (areas where different portions are covered by different sensors 102, for example). Details regarding the commissioning module 104 are described in greater detail below.

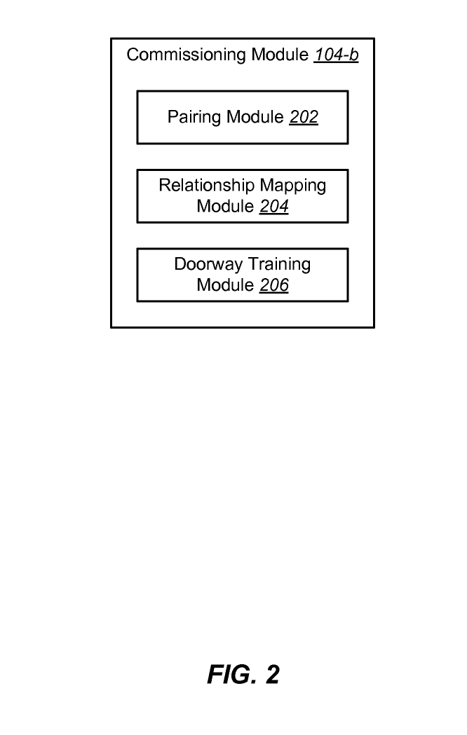

FIG. 2 is a block diagram illustrating one example of a commissioning module 104-b. The commissioning module 104-b may be one example of the commissioning module 104 illustrated in FIG. 1. In one example, the commissioning module 104-b may include a pairing module 202, a relationship mapping module 204, and a doorway training module 206.

In one embodiment, the pairing module 202 may pair a switch 108 to a sensor 102. For example, the pairing module 202 may pair a switch 108 that controls the lights in a room with a sensor 108 that monitors the occupancy of the MOM.

In some configurations, the pairing module 202 may determine which switch 108 the sensor 102 should be paired with based on the brightness change associated with each switch 108. For example, the pairing module 202 may send a broadcast that requests each switch 108 that is within range to respond with its switch identifier. The pairing module 202 may generate a list that identifies each of the switches 108 that responds based on their switch identifier. The pairing module 202 may step through the list, sending a command to each switch 108 to cycle its lights (e.g., turn the lights on and turn the lights off). The pairing module 202 may monitor the brightness change observed by the sensor 102 during the time that each switch 108 cycled its lights. The pairing module 202 may identify the switch 108 that generated the maximum brightness change for the sensor 102. For example, the pairing module 202 may identify the switch 108 that controls the lights in the room where the sensor 102 is located. The pairing module 202 may pair the identified switch 108 with the sensor 102. In one embodiment, the pairing module 202 may transmit probable pairs to a server. In this embodiment, the server may collect and consolidate pairing information into a pairing table. In some cases, the pairing module 202 may receive the pairing table from the server. The server may additionally allow automated pairing determinations to be manually overridden.

In one embodiment, the relationship mapping module 204 may learn the topology among a sensor 102 and its neighboring sensors 102. Additionally or alternatively, the relationship mapping module 204 may build a relationship table that identifies the relationships between the sensor 102 and its neighboring sensors 102. In some cases, the relationships may identify common doorways between the sensors 102. In some configurations, the relationship mapping module 204 may build a relationship table and/or generate a topology mapping for a number of sensors 102 in a sensor system.

In some configurations, the relationship mapping module 204 may determine a relationship between at least two sensors by monitoring the time between when an occupant leaves the field of view of the first sensor 102-a-1 and when an occupant enters the field of view of the second sensor 102-a-2. In one example, a sensor 102 may send a broadcast on a news channel each time an occupant enters or exits the sensor's 102 own field of view.

For example, the first sensor 102-a-1 may send a first news broadcast when an occupant enters the field of view of the first sensor 102-a-1. The first news broadcast may include an indication that an occupant has been detected, a sensor identifier of the first sensor 102-a-1, and the location (in the field of view, for example) of the detection. The first sensor 102-a-1 may send a second news broadcast when the occupant is lost from the field of view of the first sensor 102-a-1. The second news broadcast may include an indication that the occupant has been lost from view along with the sensor identifier and location information (where the occupant was last seen in the field of view, for example). The second sensor 102-a-2 may send a third news broadcast indicating that an occupant has entered the field of view of the second sensor 102-a-2.

In some configurations, the relationship mapping module 204 may determine if the time difference between the second news broadcast and the third news broadcast satisfies a predetermined threshold. For instance, if the second news broadcast and the third news broadcast happen in close proximity (e.g., the occupant is visible in both fields of view at the same time or the time between exiting one field of view and entering the other field of view is small), then the relationship module 204 may determine that a relationship exists between the first sensor 102-a-1 and the second sensor 102-a-2. In some configurations, the relationship mapping module 204 may additionally map the location of the exit in the first field of view with the location of the entrance in the second field of view to further define the relationship between the first sensor 102-a-1 and the second sensor 102-a-2. In some configurations, this relationship information may be stored in a relationship table and/or generated into a topology mapping. It may be noted that the news broadcasts may allow each of the relationship mapping modules 204 to record the relationships for the sensors 102.

In some configurations, the doorway training module 206 may determine the precise boundaries of a doorway area within a field of view. In some configurations, the entry information and exit information may be used to determine approximate locations of any doorways in a field of view. In some configurations, the doorway training module 206 may utilize image pattern recognition to identify doorway boundaries. It may be noted that the doorway training module 206 may identify doorway boundaries automatically, with minimal involvement of users for visual inspection and annotation of doorways.

For example, the doorway training module 206 may track the movements of a controller (e.g., an occupant) to determine the precise boundaries of a doorway area. In some configurations, the doorway training module 206 may monitor the field of view of a sensor 102 for a controller that enters the field of view, performs a particular doorway commissioning pattern, and exits the field of view. In some configurations, a first doorway commissioning pattern may be used for defining a doorway boundary that marks the doorway from an area that that is outside of the doorway but still in the field of view of the sensor 102. In some configurations, a second doorway commissioning pattern may be used for defining a doorway area. In some cases, the doorway training module 206 may enable the sensor 102 to ignore activity that occurs outside of the doorway. In some configurations, the doorway training module 206 may additionally enable the sensor 102 to identify a window (using a window commissioning pattern, for example).

In some cases, a sensor 102 may not output any image data. For example, the sensor 102 may not be able to output image data and/or may be locked from outputting image data. Additionally, a sensor 102 may not include any configuration buttons. In this scenario, the commissioning module 104-b may manage the commissioning of the sensor 102. In some configurations, the commissioning module 104-b may enable a sensor 102 to be commissioned automatically (e.g., without the need for users to specify pairings, define relationships, or visually inspect and annotate doorways).

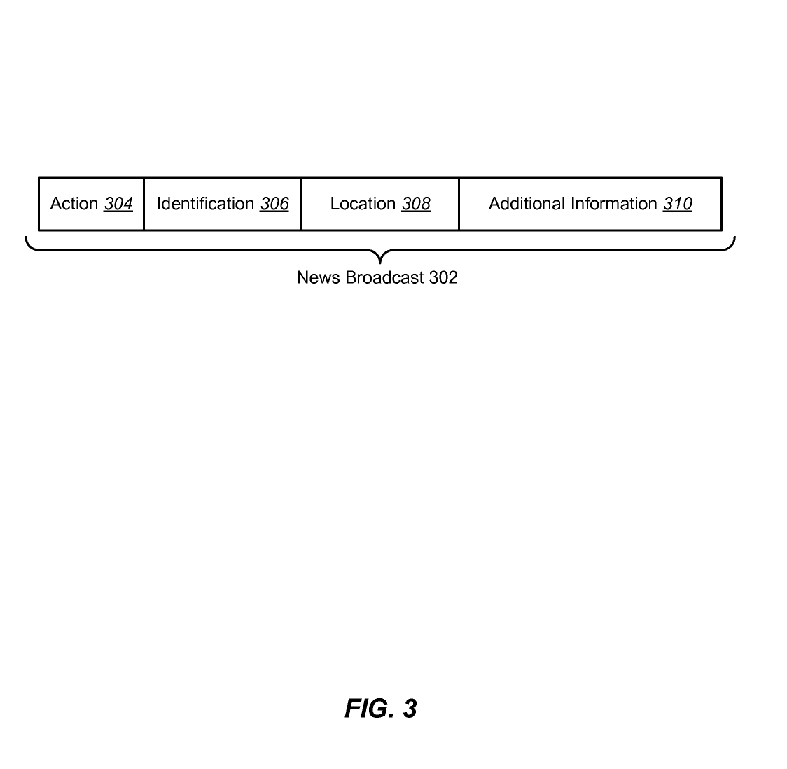

FIG. 3 is a block diagram illustrating one example of a news broadcast 302. In some configurations, the news broadcast 302 may include an action portion 304, an identification portion 306, a location portion 308, and an additional information portion 310.

In one embodiment, the portion for the action 304 may include a description of an action event. For example, the action 304 may indicate that an occupant was found, an occupant was lost, an entry event, an exit event, an occupancy state of a room (e.g., the room is occupied, the room is unoccupied), the number of occupants in the room, etc.

In one embodiment, the identifier portion 306 may include a sensor identifier for the sensor that is transmitting the news broadcast 302. For example, if a first sensor 102-a-1 generates the news broadcast 302, the identifier portion 306 may indicate that the first sensor 102-a-1 initiated the broadcast.

In one embodiment, the location portion 308 may be used to identify the location associated with an occupant. For example, the location portion 308 may indicate the location where an occupant entered, the current location of the occupant, and/or the location where an occupant exited. In another example, the location portion 308 may identify the location of a doorway or a significant feature. In some configurations, the location portion 308 may represent a location in the field of view of the identified (e.g., identifier portion 308) sensor 102.

In some configurations, the location portion 308 may be used to build a relationship between doorways in one field of view and doorways in another field of view. For example, an occupant that exits a first field of view (e.g., first room) may be identified by a first location in the location portion 308. If the occupant enters a second field of view (e.g., second room), the occupant may be identified by a second location in the location portion 308. In this scenario, a specific relationship between the first location and the second location in the location portion 308 may be generated (and stored in the relationship table, for example).

In some embodiments, the additional information portion 310 may include occupant details, synchronization information, commissioning information, etc. In some configurations, the news broadcast 302 may be broadcast over the network 106. For example, the news broadcast 302 may be communicated to a number of sensors 102 and/or switches 108 in a sensor system through the network 106.

In one configuration, a pairing process may be used to pair a switch 108 with a sensor 102. In some configurations, the pairing process may be managed by one or more pairing modules 202.

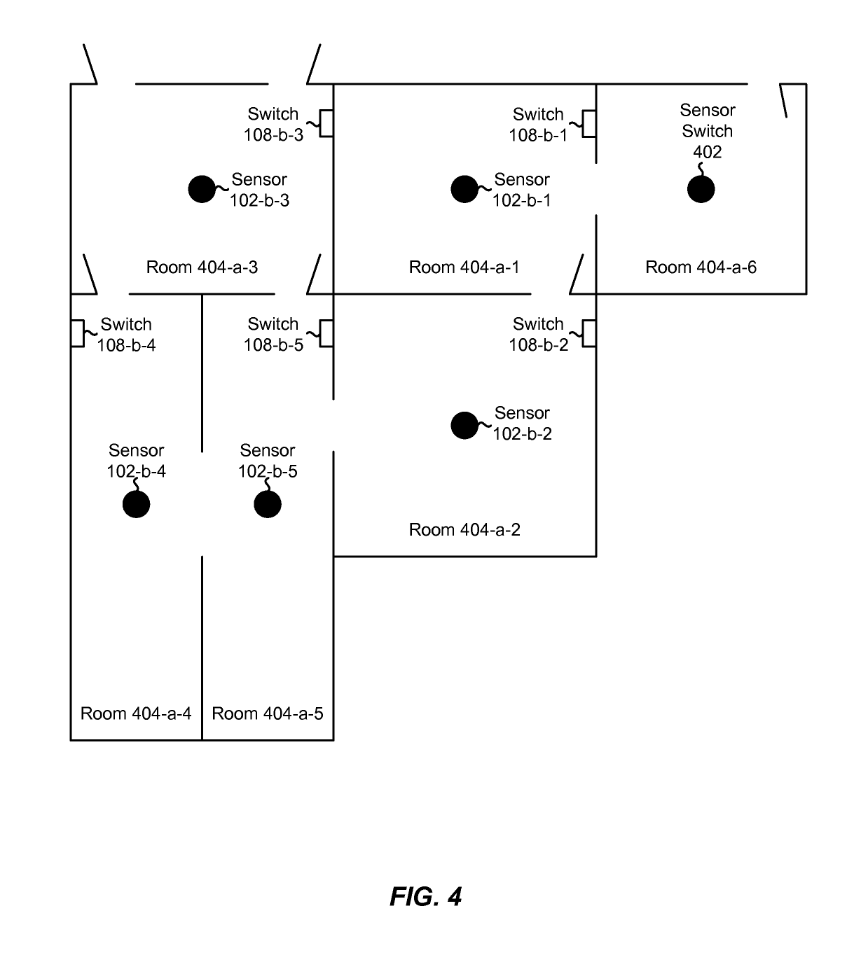

FIG. 4 is a block diagram illustrating one embodiment of a building in which the systems and methods described herein may be implemented. In some configurations, a plurality of sensors 102 and a plurality of switches 108 may be installed in a plurality of rooms 404. The sensors 102 and switches 108 may be examples of the sensors 102 and switches 108 of FIG. 1.

In one example, a first sensor 102-b-1 and a first switch 108-b-1 may be installed in a first room 404-a-1, a second sensor 102-b-2 and a second switch 108-b-2 may be installed in a second room 404-a-2, a third sensor 102-b-3 and a third switch 108-b-3 may be installed in a third room 404-a-3, a fourth sensor 102-b-4 and a fourth switch 108-b-4 may be installed in a fourth room 404-a-4, and a fifth sensor 102-b-5 and a fifth switch 108-b-5 may be installed in a fifth room 404-a-5. In one embodiment, a sensor switch 402 may be installed in a sixth room 404-a-6. In some configurations, the sensor switch 402 may integrate a sensor 102 and a switch 108 into a single device.

It may be noted, that in some cases, a single sensor 102 may determine occupancy for a single room 404. In these cases, the single sensor 102 may determine both the occupancy of the room 404 and the location of each occupant in the room. In other cases, multiple sensors 102 may determine occupancy for a single room 404 or for open areas (e.g., the area between the fourth room 404-a-4 and the fifth room 404-a-5). In these cases, different sensors 102 may cover different portions of the open area. For example, the fifth sensor 102-b-5 may cover the portion of the open area in the fifth room 404-a-5 and the fourth sensor 102-b-4 may cover the portion of the open area in the fourth room 404-a-4. In some cases, a virtual boundary between portions of an open area may be determined (based on the field of view of the sensors 102, for example). In some cases, the virtual boundary may be treated as a doorway. For example, the virtual boundary may be used to identify the relationship between the fourth sensor 102-b-4 and the fifth sensor 102-b-5 (indicating that they cover adjacent portions of the open area between the fourth room 404-a-4 and the fifth room 404-a-5). In some cases, this may allow the relationship between the two or more portions of an open area to be determined.

In some cases, the sensor switch 402 may act as a single device with a single identifier. In other cases, the sensor switch 402 may act as a separate sensor 102 with a unique sensor identifier and as a separate switch 108 with a unique switch identifier. In some cases, the switch portion of the integrated sensor 402 may already be paired with the sensor portion of the integrated sensor 402.

In some configurations, a switch 108 may control the lights in a room. For example, the first switch 108-b-1 may control the lights in the first room 404-a-1, the second switch 108-b-2 may control the lights in the second room 404-a-2, and so forth.

In some configurations, one or more of the sensors 102 may not be paired with a switch 108. For example, the first switch 108-b-1 may have no indication that it shares the first room 404-a-1 with the first sensor 102-b-1. In some configurations, one or more of the commissioning modules 104 installed on the sensors 102 may indicate that a pairing process should occur. In one example, one or more of the commissioning modules 104 may receive a pairing request from one or more switches 108.

In some configurations, the sensors 102 may wait for a synchronization event. Examples of a synchronization event include a natural event (e.g., night, daybreak, etc.), a synchronization signal from another device (e.g., server, mobile device), a specified time from a clock, or any other usable synchronization event. In one example, the synchronization event may be the occurrence of night (e.g., a period of darkness). In this configuration, the sensors 102 may perform local observations to determine the brightness level in their respective rooms 404. In some configurations, a sensor 102 may detect the occurrence of night when the brightness level in a room 404 decreases below a certain threshold.

In some configurations, the sensors 102 may communicate with each other to agree (e.g., come to a consensus) that the synchronization event has occurred. This may be important when the synchronization event is the occurrence of night because a sensor 102 that is in an interior rooms (without windows, for example) may be consistently dark (e.g., the brightness in the room is below the threshold) during the day. Thus, a sensor 102 in an interior room may communicate with a sensor 102 in an exterior room (that has access to natural lighting, windows, for example) to come to a consensus on when the synchronization event (the occurrence of night, for example) has occurred. Additionally or alternatively, the sensors 102 may communicate with a server to determine whether the synchronization event has occurred.

Upon the detection of a synchronization event, one of the sensors 102 may be selected to be the first sensor 102 to go through the pairing process. Examples of selection procedures include a random selection, a pre-assigned ordering, a selection based on a switch identifier, a selection based on a media access control (MAC) address, etc. In some configurations, going through the pairing process includes sequentially turning each switch 108 on and then off and then determining which switch 108 corresponds with the maximum brightness change for the sensor 102. The switch 108 that corresponds to the maximum brightness change for the sensor 102 may be paired with the sensor 102.

For example, a first sensor 102-b-1 may be selected to go first. In one configuration, the first sensor 102-b-1 may send a broadcast to a number of the switches 108 to request each switch 108 to respond with its switch identifier. In one embodiment, the first sensor 102-b-1 may receive a switch identifier from each of the switches 108. In some configurations, the first sensor 102-b-1 may generate a list of the switches 108 that responded. In some cases, each switch 108 may be identified by its switch identifier.

In some configurations, the first sensor 102-b-1 may sequentially step through the list of switches 108 to determine the switch(es) 108 that it should be paired with. For example, the first sensor 102-b-1 may send a command to the first switch 108-b-1 for the first switch 108-b-1 to turn on the lights. The first sensor 102-b-1 may perform local observations to determine the brightness change associated with the first switch 108-b-1 being turned on. In some configurations, the first sensor 102-b-1 may record the brightness change that occurred when the first switch 108-b-1 turned on the lights. The first sensor 102-b-1 may send a command to the first switch 108-b-1 for the first switch 108-b-1 to turn off the lights. Once the first switch 108-b-1 turns off the lights, the first sensor 102-b-1 may send a command to the second switch 108-b-2 for the second switch 108-b-2 to turn on the lights. The first sensor 102-b-1 may continue with the process described above and may repeat the process for each switch 108 in the list. The first sensor 102-b-1 may identify the switch 108 that was associated with the maximum brightness change for the first sensor 102-b-1. In this case, the first switch 108-b-1 controls the lights for the first room 404-a-1, which is where the first sensor 102-b-1 is installed, and therefore the first sensor 102-b-1 may associate the first switch 108-b-1 with the maximum brightness change. In this case, the first sensor 102-b-1 may indicate to the first switch 108-b-1 that it should be paired with the first sensor 102-b-1.

In some configurations, the first sensor 102-b-1 may have a tag indicating that it is paired with the first switch 108-b-1. Similarly, the first switch 108-b-1 may include a tag that indicates that it is paired with the first sensor 102-b-1 may include a tag indicating that it is paired with the first sensor 102-b-1. In some configurations, a notification of the pairing between the first switch 108-b-1 and the first sensor 102-b-1 may be broadcast to the other sensors 102 over the news channel.

In some cases, it may not be necessary for a sensor 102 to step through the entire list of switches 108. For example, if the sensor 102 detects that the brightness change associated with the turning on of a switch 108 satisfies a predetermined threshold, the sensor 102 may select that switch 108 as the switch 108 that the sensor 102 should be paired with.

Once the first sensor 102-b-1 has completed the pairing process, a second sensor 102-b-2 may be selected to go through the pairing process. In one configuration, the second sensor 102-b-2 may send a broadcast to a number of the switches 108 requesting their switch identifiers, as described previously. In another configuration, the second sensor 102-b-2 may utilize a list of switch identifiers that was generated when the switches 108 responded to the first broadcast from the first sensor 102-b-1. In some cases, the second sensor 102-b-2 may remove the first switch 108-b-1 from the list because it is no longer available (e.g., it is already paired with the first sensor 102-b-1).

In some configurations, the second sensor 102-b-2 may sequentially step through the list of switches 108 to determine the switch(es) 108 that it should be paired with. As described previously, the second sensor 102-b-2 may monitor the brightness change that is associated with each switch 108 that is turned on. In one example, the second sensor 102-b-2 may observe that the change in brightness associated with the fifth switch 108-b-5 was small, that the change in brightness associated with the fourth switch 108-b-4 was extremely small, that there was no change in brightness associated with the third switch 108-b-3, and that there was a substantial change in brightness associated with the second switch 108-b-2. In this case, the second sensor 102-b-2 may indicate to the second switch 108-b-2 that it should be paired with the second sensor 102-b-2. Once the second sensor 102-b-2 has completed the pairing process, the third sensor 102-b-3 may be selected to go through the pairing process, and so forth until each of the switches 108 have been paired with a sensor 102.

In some configurations, multiple switches 108 (in one room 404, for example) may be paired with, or controlled by, a single sensor 102. For example, when a sensor 102 requests that each switch 108 turns on its respective set of lights, the sensor 102 may check if a change in brightness in its field of view satisfies a predetermined threshold. In some cases, the sensor 102 may add all of the switches with a change in brightness that satisfied the threshold to its pairing list. In some embodiments, a sensor 102 may identify each doorway in its field of view, before checking if the change in brightness associated with a switch 108 satisfies the predetermined threshold. In one example, a sensor 102 may determine if the change in brightness caused by lights that are inside a doorway or caused by lights that are outside the doorway. It may be noted, that in some configurations, all switches 108 and all sensors 102 may be associated (e.g., paired).

In some cases, spaces (that turn corners of corridors and/or that have strange geometry, for example) may not have an obvious concept of “center of a room” (which is the typical installation location) where an installer may place the sensor 102 in the ceiling. In such situations, an installer may use a mobile device (e.g., a mobile phone) and/or a battery operated version of the sensor that may be capable of sending (e.g., outputting) an images (to the installer's laptop, for example) to evaluate the field of view at various locations. In some cases, this may allow the installer to try a few different locations and install the sensor in a location that provides coverage of the maximum number of doorways.

In one configuration, a relationship mapping process may be used to map relationships between sensors 102. For example, the relationship mapping process may be used to determine that a doorway in the field of view of a first sensor 102-b-1 corresponds to a doorway in the field of view of a second sensor 102-b-2. In some configurations, the relationship mapping process may be managed by one or more relationship mapping modules 204.

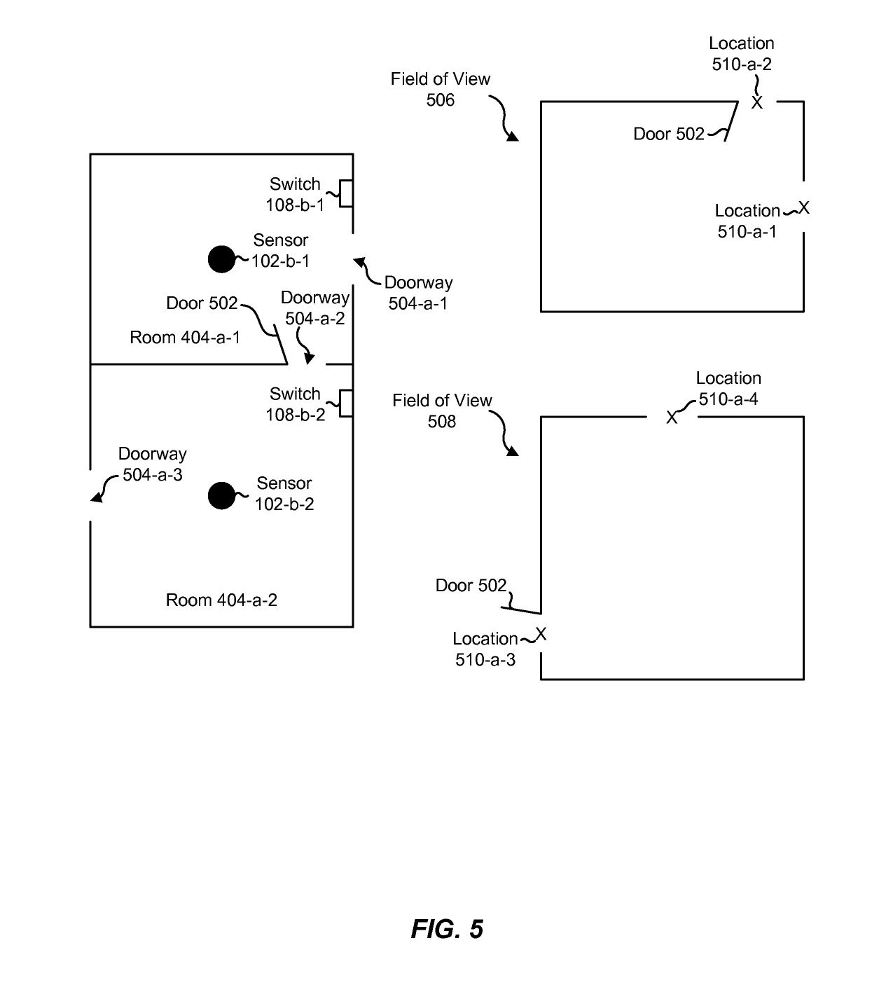

FIG. 5 is a block diagram illustrating one example of a field of view 506, 508 that may be associated with a room 404. As described previously, a sensor 102 may capture image data with an image sensor. In some configurations, the image data may include a field of view 506, 508 of the sensor 102. In some configurations, the field of view 506, 508 may vary depending on where the sensor 102 is located in a room 404. Additionally or alternatively, the field of view 506, 508 may vary depending on the orientation of the sensor 102. In some configurations, the location and/or orientation of the sensor 102 may be randomly determined at the time of installation. Thus, in some cases, the field of view 506, 508 of a sensor 102 may be a rotated and/or flipped version of a room 404. In one example, the first sensor 102-b-1 may have a field of view 506 of the first room 404-a-1 and the second sensor 102-b-2 may have a field of view 508 of the second room 404-a-2. The field of view 506 of the first sensor 102-b-1 may be a rotated and/or flipped (e.g., rotated 180 degrees and flipped) version of the first room 404-a-1. Similarly, the field of view 508 of the second sensor 102-b-2 may be a rotated and/or flipped (e.g., rotated clockwise 90 degrees and flipped) version of the second room 404-a-2.

In one embodiment, the first room 404-a-1 may have a first doorway 504-a-1 and a second doorway 504-a-2. Additionally, the second room 404-a-2 may have the second doorway 504-a-2 and a third doorway 504-a-3. As illustrated, the first room 404-a-1 may be connected to the second room 404-a-2 through the second doorway 504-a-2. In one embodiment, the second doorway 504-a-2 may include a door 502. In some cases, the first doorway 504-a-1 and the third doorway 504-a-3 may each correspond to an open area.

In some configurations, the sensors 102 may not know their relationship with respect to each other. For example, the first sensor 102-b-1 may not know that the second sensor 102-b-2 exists and/or is a neighbor. Similarly, the second sensor 102-b-2 may not know that the first sensor 1-2-b-1 exists and/or is a neighbor. In one embodiment, the first sensor 102-b-1 may have a door 502 in its field of view 506. In one embodiment, the second sensor 102-b-2 may also have a door 502 in its field of view 508. However, the first sensor 102-b-1 and the second sensor 102-b-2 may be unaware that the door 502 in the field of view 506 is the same door that is in the field of view 508. As noted previously, in some cases, a field of view may include one or more virtual boundaries (for one or more open areas, for example) that are treated as doorways for the relationship mapping process.

In one configuration, a relationship mapping process may be carried out by the commissioning module 104. In some configurations, the relationship mapping process may begin when a commissioning indication is obtained. Examples of a commissioning indication include a natural event (e.g., daybreak following the pairing process), a signal from a controller, a signal from an electronic device, a specified time, etc. In one example, the sensors 102 may begin the relationship mapping process following the pairing process (e.g., when the first switch 108-b-1 is paired with the first sensor 102-b-1 and when the second switch 108-b-2 is paired with the second sensor 102-b-2).

During the relationship mapping process, the sensors 102 may monitor their field of view 506, 508 for an occupant. In some configurations, each sensor 102 may be send a news broadcast when an occupant is visible in their field of view and to send a news broadcast when the occupant is no longer visible in their field of view. In some configurations, the relationship mapping process may include a controller (e.g., occupant, user, trainer) walking through one or more doorways. In some configurations, a single controller may be used. In another configuration, multiple controllers may be used. In the case of multiple controllers, the sensors 102 may uniquely identify each controller (based on a digital signature of their clothing, for example) so that the sensors 102 may track which controller is moving from one sensor 102 to another sensor 102.

In one example, the first sensor 102-b-1 may detect that an occupant entered its field of view 506 at a first location 510-a-1. For example, the first sensor 102-b-1 may detect the occupant in its field of view 506 when the occupant enters the first doorway 504-a-1. In some configurations, the first sensor 102-b-1 may send a first news broadcast indicating that an occupant entered its field of view at the first location 510-a-1. In some configurations, the first sensor 102-b-1 may track the occupant while it is in its field of view 506.

In one example, the first sensor 102-b-1 may detect that the occupant exited its field of view 506 at a second location 510-a-2. For example, the first sensor 102-b-1 may detect that the occupant was lost from its field of view 506 when the occupant exits the second doorway 504-a-2. In some configurations, the first sensor 102-b-1 may send a second news broadcast indicating that the occupant exited its field of view 506 at the second location 510-a-2.

At approximately the same time (e.g., in close proximity), the second sensor 102-b-2 may detect that an occupant entered its field of view 508 at a third location 510-a-3. For example, the second sensor 102-b-2 may detect the occupant enter its field of view 508 when the occupant enters the second doorway 504-a-2. In some configurations, the second sensor 102-b-2 may send a third news broadcast indicating that an occupant entered its field of view at the third location 510-a-3. In some configurations, the occupant may be visible in the field of view 506 of the first sensor 102-b-1 and the field of view 508 of the second sensor 102-b-2 at approximately the same time. In other configurations, the occupant may enter the field of view 508 of the second sensor 102-b-2 shortly after exiting the field of view 506 of the first sensor 102-b-1. In some configurations, the second sensor 102-b-2 may track the occupant while it is in its field of view 508.

In one example, the second sensor 102-b-2 may detect that the occupant exited its field of view 508 at the fourth location 510-a-4. For example, the second sensor 102-b-2 may detect that the occupant was lost from its field of view 508 when the occupant exits a third doorway 504-a-3. In some configurations, the second sensor 102-b-2 may send a fourth news broadcast indicating that the occupant exited its field of view 508 at the fourth location 510-a-4.

In one embodiment, the first sensor 102-b-1 may identify that its field of view 506 includes a doorway (e.g., an approximate location of a doorway) at the first location 510-a-1 and at the second location 510-a-2. Similarly, the second sensor 102-b-2 may identify that its field of view 508 includes a doorway (e.g., an approximate location of a doorway) at the third location 510-a-3 and at the fourth location 510-a-4. In some configurations, the locations 510 correspond to entrances and/or exits of a room 404.

In one embodiment, the first sensor 102-b-1 may determine a relationship between itself and the second sensor 102-b-2. For example, the first sensor 102-b-1 may determine that a relationship with the second sensor 102-b-2 exists because the second sensor 102-b-2 detected the occupant in its field of view 508 in close proximity (e.g., within a predetermined threshold of time) to when the first sensor 102-b-1 lost the occupant from its field of view 506. Additionally or alternatively, the first sensor 102-b-1 may determine that the doorway associated with the second location 510-a-2 for the first sensor 102-b-1 leads to (e.g., is the same doorway as) the doorway associated with the third location 510-a-3 for the second sensor 102-b-1.

Similarly, the second sensor 102-b-2 may determine a relationship between itself and the first sensor 102-b-1 because the first sensor 102-b-1 lost an occupant from its field of view 506 in close proximity (e.g., within a predetermined threshold of time) to when the second sensor 102-b-2 detected an occupant in its field of view 508. Additionally or alternatively, the second sensor 102-b-2 may determine that the doorway associated with the second location 510-a-2 for the first sensor 102-b-1 leads to (e.g., is the same doorway as) the doorway associated with the third location 510-a3 for the second sensor 102-b-2.

Additionally or alternatively, any sensor 102 or device that is coupled to the network 106 may determine that a relationship exists between the first sensor 102-b-1 and the second sensor 102-b-2 based on the close proximity (e.g., within a predetermined threshold of time) of the second news broadcast and the third news broadcast. Similarly, any sensor 102 or device that is coupled to the network 106 may determine that the doorway associated with the second location 510-a-2 for the first sensor 102-b-1 leads to (e.g., is the same doorway as) the doorway associated with the third location 510-a-3 for the second sensor 102-b-2.

In some configurations, each sensor 102 may generate a complete topology of sensor relationships. For example, each sensor 102 may have a topology map of the building based on the relationships (e.g., between doorways, walls, windows, open areas, etc.) determined between each sensor 102. For instance, a topology map may be generated for the building illustrated in FIG. 4. In one example, the topology map for the building may identify the relationships between the sensors for each of the common doorways. For instance, in one example, FIG. 4 may represent a topology map (e.g., illustrating the neighbor relationship between rooms 404 as well as the specific doorways between the rooms 404).

It may be noted, each sensor 102 may send relationship information to a server that may generate a topology mapping. In some cases, each sensor 102 may receive the generated topology mapping from the server.

In one configuration, a doorway training process may be used to define precise boundaries of a doorway. For example, the doorway training process may be used to define the boundary between the doorway and area that is the field of view of the sensor 102 but outside of a room 404. In some configurations, the doorway training process may be managed by one or more doorway training modules 206.

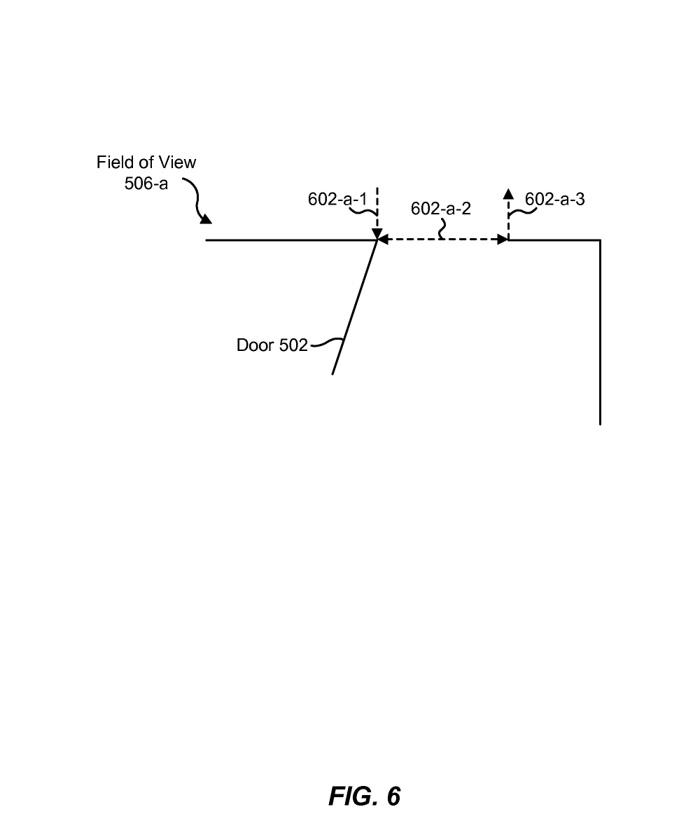

FIG. 6 is a block diagram illustrating one example of a doorway training process for a doorway in a field of view 506-a. For example, the field of view 506-a may be one example of the field of view 506 illustrated in FIG. 5. As illustrated, the field of view 506-a includes a door 502. In some cases, the door 502 may correspond to the door 502 illustrated in FIG. 5. In some configurations, a doorway training process may be used to define a boundary between the doorway and area that is outside of the doorway but still in the field of view of the sensor 102. For example, the area that is outside of the doorway may be identified so it may be ignored by the sensor 102.

In one embodiment, the first sensor 102-b-1 may monitor the doorway for a first commissioning pattern. In some configurations, the first commissioning pattern may include a first path 602-a-1 by a controller (e.g., an occupant) that brings the controller into the field of view 506-a of the first sensor 102-b-1 to a first endpoint (e.g., a first doorpost). Additionally the first commissioning pattern may include a second path 602-a-2 by the controller that is repeated (e.g., at least once) between the first end point and a second endpoint (e.g., the second doorpost of a doorway). Additionally the first commissioning pattern may include a third path 602-a-3 by the controller that takes the controller from the second endpoint to out of the field of view 506-a of the first sensor 102-b-1.

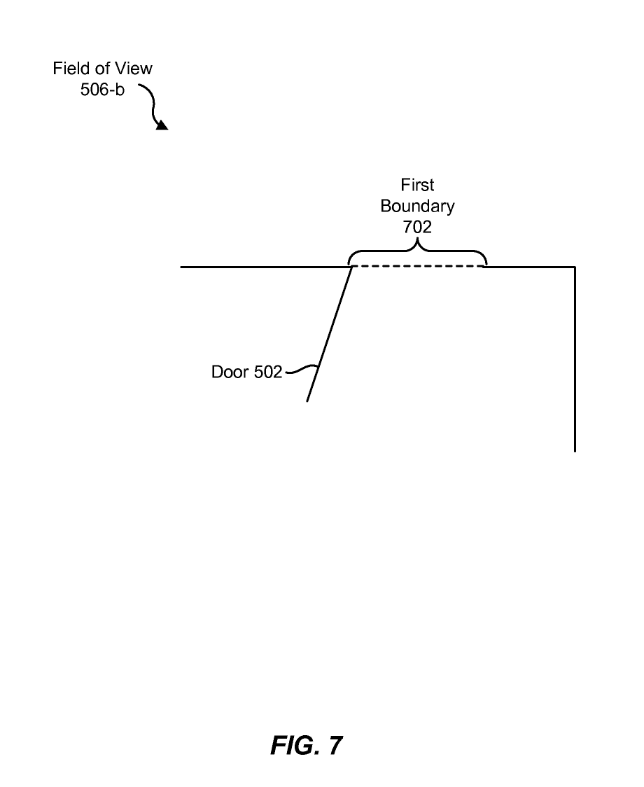

FIG. 7 is a block diagram illustrating another example of the doorway training process for a doorway in a field of view 506-b. For example, the field of view 506-b may be one example of the field of view 506 illustrated in FIG. 5 or 6. As illustrated, the field of view 506-b includes a door 502. In some cases, the door 502 may correspond to the door 502 illustrated in FIG. 5.

Upon detection of the first commissioning pattern, the first sensor 102-b-1 may identify a first boundary 702 based on the second path 602-a-2. For example, the first sensor 102-b-1 may approximate the first boundary 702 based on the repeated path between the first endpoint and the second endpoint. In some configurations, the first boundary 702 may be used by the first sensor 102-b-1 to ignore activity that occurs outside of the first boundary 702.

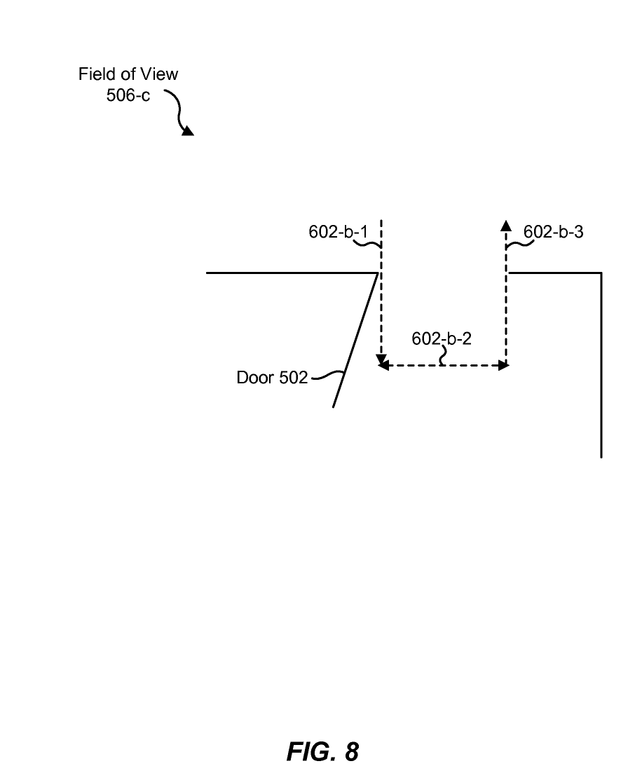

FIG. 8 is a block diagram illustrating another example of the doorway training process for a doorway in a field of view 506-c. For example, the field of view 506-c may be one example of the field of view 506 illustrated in FIG. 5, 6, or 7. As illustrated, the field of view 506-c includes a door 502. In some cases, the door 502 may correspond to the door 502 illustrated in FIG. 5.

In one embodiment, the first sensor 102-b-1 may monitor the doorway for a second commissioning pattern. In some configurations, the second commissioning pattern may include a first path 602-b-1 by a controller (e.g., an occupant) that brings the controller into the field of view 506-c of the first sensor 102-b-1 and within the doorway a short distance (e.g., 2 feet from the first end point) to a third endpoint. Additionally the second commissioning pattern may include a second path 602-b-2 by the controller that is repeated (e.g., at least once) between the third end point and a fourth endpoint (e.g., 2 feet from the second end point). Additionally the second commissioning pattern may include a third path 602-b-3 by the controller that takes the controller from the fourth endpoint to out of the field of view 506-c of the first sensor 102-b-1.

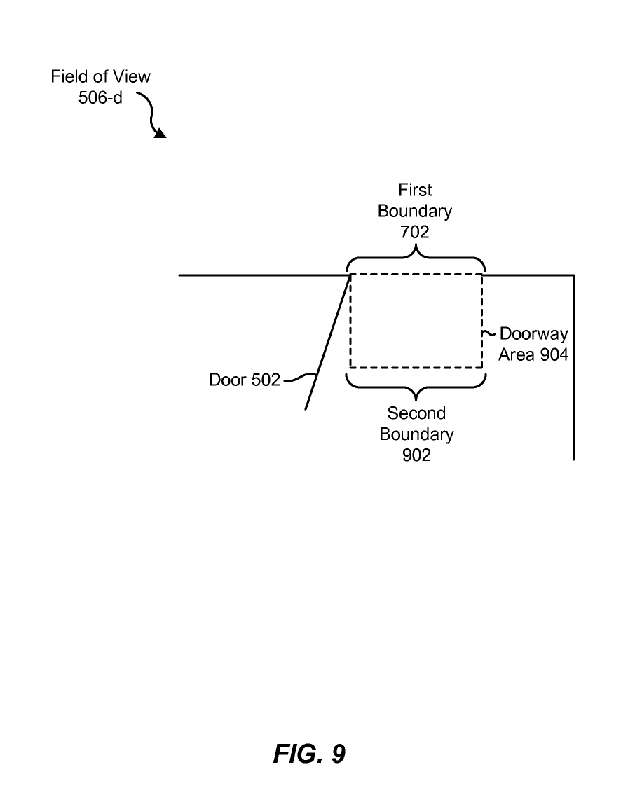

FIG. 9 is a block diagram illustrating another example of the doorway training process for a doorway in a field of view 506-d. For example, the field of view 506-d may be one example of the field of view 506 illustrated in FIG. 5, 6, 7, or 8. As illustrated, the field of view 506-d includes a door 502. In some cases, the door 502 may correspond to the door 502 illustrated in FIG. 5.

Upon detection of the second commissioning pattern, the first sensor 102-b-1 may identify a second boundary 902 based on the second path 602-b-2. For example, the first sensor 102-b-1 may approximate the second boundary 902 based on the first path 602-b-1 between the first endpoint and the third endpoint, the repeated path between the third endpoint and the fourth endpoint, and the third path 602-b-3 between the fourth endpoint and the second endpoint. In some configurations, the second boundary 902 may be used by the first sensor 102-b-1 to determine a doorway area 904. In some configurations, the doorway area 904 may be an area bounded by the first boundary 702 and the second boundary 902. In some cases, the doorway area 904 may be used to identify whether an occupant is entering or exiting the doorway.

In one embodiment, the doorway area 904 may be used to determine if an occupant is standing inches outside of the room 404 or if the occupant is standing inches within the room 404. Thus, the sensor 102 may ignore activity that occurs outside the room boundary identified by the first boundary 702. For example, a person that is walking outside of the first boundary 702 may be ignored.

In an additional or alternative doorway training process, an image from a sensor 102 is transmitted either to a handheld device or across the network to a controller and/or operator by the commissioning module 104. The controller and/or operator may draw, by hand or touch, markings (e.g., lines) on the image to indicate doorways or windows. In some configurations, these markings may be extrapolated into polygons, lines, and/or endpoints that are transmitted back to the commissioning module 104.

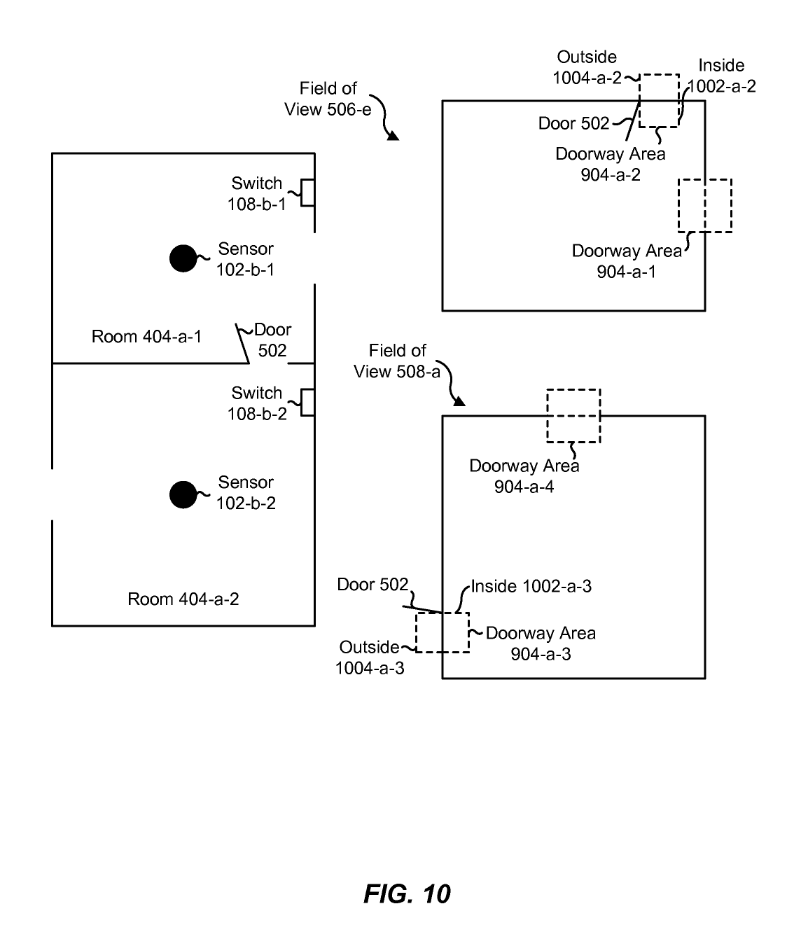

FIG. 10 is a block diagram illustrating one example of a field of view 506-e, 508-a following the commissioning process. For example, field of view 506-e may be one example of the field of view 506 illustrated in FIG. 5, 6, 7, 8, or 9. Similarly, field of view 508-a may be one example of the field of view 508 illustrated in FIG. 5. As illustrated, the field of view 506-e and the field of view 508-a include a door 502. In some cases, the door 502 may correspond to the door 502 illustrated in FIG. 5.

In one embodiment, each switch 108 may be paired with the proper sensor 102. For example, the first switch 108-b-1 may be paired with the first sensor 102-b-1 and the second switch 108-b-2 may be paired with the second sensor 102-b-2. Additionally, each sensor 102 may have a topology mapping of the neighboring relationships between sensors 102. For example, each sensor 102 may be aware that the second doorway area 904-a-2 that is in the field of view 506-e of the first sensor 102-b-1 is coupled to the third doorway area 904-a-3 in the field of view 508-a of the second sensor 102-b-2. Similarly, each sensor 102 may be aware that the first doorway area 904-a-1 couples the first room 404-a-1 to the sixth room 404-a-6 and that the fourth doorway area 904-a-4 couples the second room 404-a-2 to the fifth room 404-a-5. In some configurations, each doorway area 904 may include an inside doorway area 1002 and an outside doorway area 1004. For example, the second doorway area 904-a-2 may include a second inside door area 1002-a-2 and a second outside door area 1004-a-2. Similarly, the third doorway area 904-a-3 may include a third inside door area 1002-a-3 and a third outside door area 1004-a-3. In some configurations, the inside doorway area 1002 may identify the area just inside the door and the outside door area 1004 may identify the area just outside the door. For example, the second sensor 102-b-2 may know if an occupant is standing inches outside a doorway (in the second outside door area 1004-a-2, for example) or is standing inches inside a doorway (in the second inside door area 1002-a-2, for example). In some cases, the third outside door area 1004-a-3 may correspond to the second inside door area 1002-a-2 and the second outside door area 1004-a-2 may correspond to the third inside door area 1002-a-3. Thus, the precise boundaries of the doorways may have been determined. In some configurations, the inside door area 1002 and the outside door area 1004 may be used to determine if an occupant is leaving or entering a room 404 (or a portion of an open area, for example).

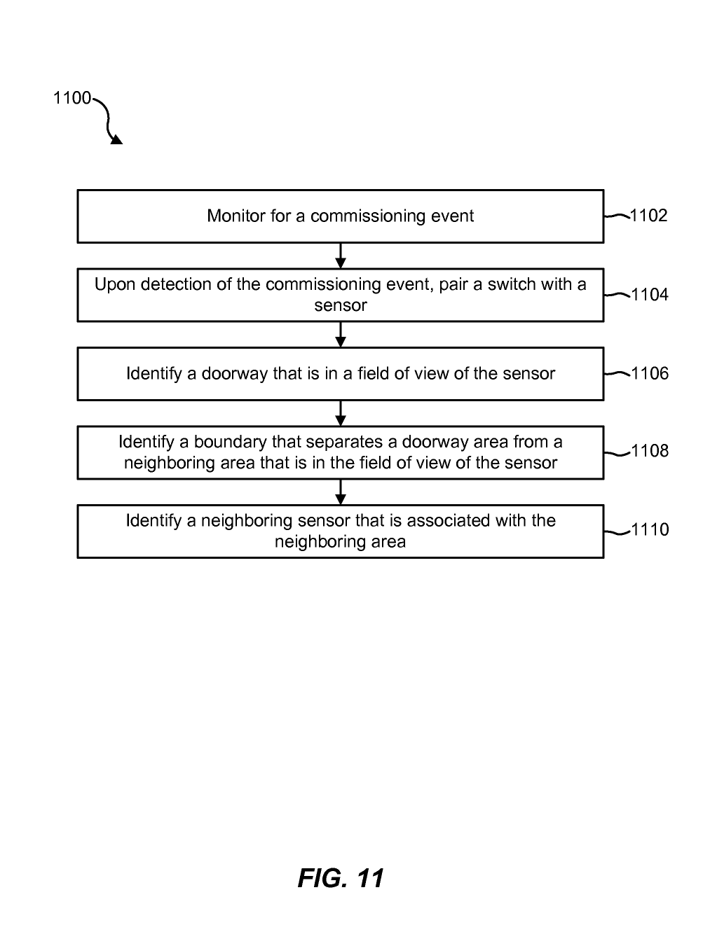

FIG. 11 is a flow diagram illustrating one example of a method 1100 for commissioning a sensor. The method 1100 may be implemented by the sensor of FIG. 1, 4, 5, or 10. In particular, the method 1100 may be implemented by the commissioning module 104 of FIG. 1 or 2.

At step 1102, an occurrence of a commissioning event may be monitored. For example, the commissioning event could be a natural event (e.g., night, day, etc.), a signal from over a network 106, a timing event based on the timing from a central timing source (e.g., a GPS clock signal). Upon detection of the commissioning event, at step 1104, a switch 108 may be paired with a sensor 102. For instance, a switch 108 may be paired with a sensor 102 using the pairing process described previously.

At step 1106, a doorway that is in the field of view of a sensor may be identified. For example, the doorway may be identified using the relationship mapping process described previously. At step 1108, a boundary that separates a doorway area from a neighboring area may be identified. For example, the boundary may be identified using the doorway training process described previously. At step 1110, a neighboring sensor that is associated with the neighboring area may optionally be identified. For example, the neighboring sensor may be identified using the relationship mapping process described previously.

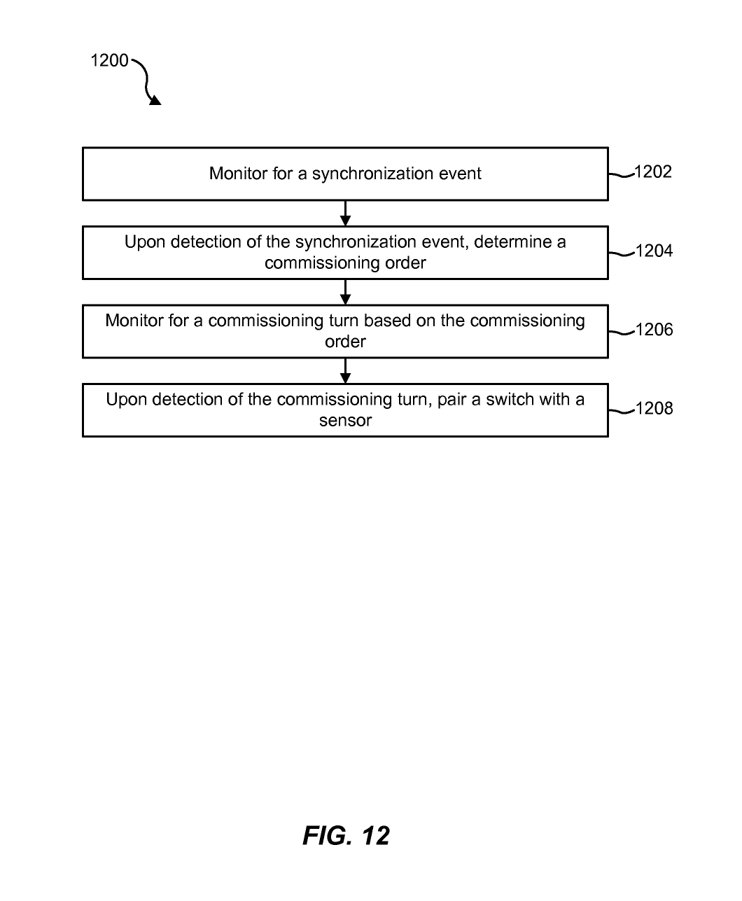

FIG. 12 is a flow diagram illustrating one example of a method 1200 for pairing a switch 108 with a sensor 102. The method 1200 may be implemented by the sensor of FIG. 1, 4, 5, or 10. In particular, the method 1200 may be implemented by the commissioning module 104 of FIG. 1 or 2

At step 1202, an occurrence of a synchronization event may be monitored. In some configurations, each sensor 102 may monitor for a synchronization event. Upon detection of the synchronization event, at step 1204, a commissioning order may be determined. For example, the commissioning order may determine the order that the sensors 102 go through the pairing process. At step 1206, a commissioning turn may be monitored. For example, the commissioning turn may be based on the commissioning order. In one configuration, the commissioning order may indicate that a sensor 102 wait for its commissioning turn while another sensor 102 performs the pairing process. Upon detection of the commissioning turn, at step 1208, a switch may be paired with a sensor.

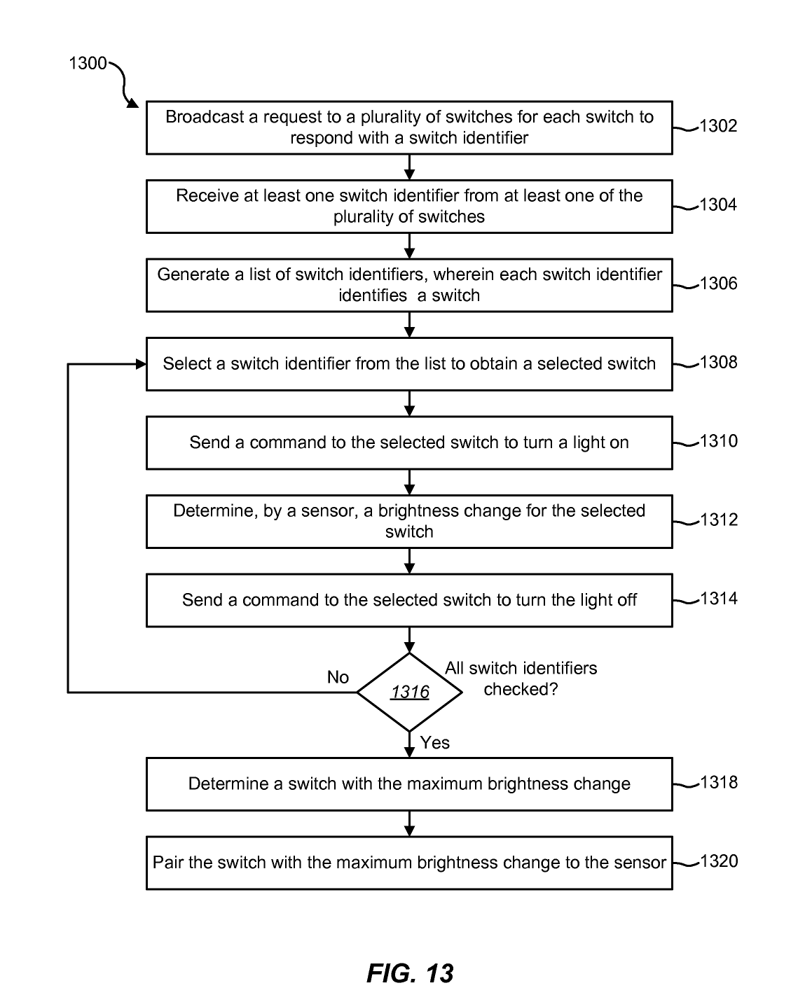

FIG. 13 is a flow diagram illustrating another example of a method 1300 for pairing a switch 108 with a sensor 102. The method 1300 may be implemented by the sensor of FIG. 1, 4, 5, or 10. In particular, the method 1300 may be implemented by the commissioning module 104 of FIG. 1 or 2

At step 1302, a request may be broadcast to a plurality of switches 108 for each switch 108 to respond with a switch identifier. At step 1304, at least one switch identifier from at least one of the plurality of switches may be received. At step 1306, a list of switch identifiers may be generated. In some configurations, each switch identifier may identify a switch. At step 1308, a switch identifier may be selected from the list. For example, in one configuration the switch identifiers may be ordered in the list based on the order of receipt. In another example, the switch identifiers may be ordered in the list based on a sorting of the switch identifiers. At step 1310, a command (to turn the light on, for example) may be sent to the switch associated with the switch identifier. At step 1312, a brightness change for the switch 108 associated with the switch identifier may be determined by the sensor 102. At step 1314, a command to turn the light off may be sent to the switch associated with the switch identifier. At step 1316, a determination may be made as to whether all of the switch identifiers have been checked. For example, a determination may be made as to whether all the switch identifiers in a list have been cycled through. If it is determined 1316 that all of the switch identifiers have not been checked, the method 1300 may return to step 1308 and continue from step 1308 as discussed previously. If, however, it is determined that all of the switch identifiers have been checked, the method 1300 may continue to step 1318. At step 1318, the switch with the maximum brightness change may be determined. At step 1320, the switch with the maximum brightness change may be paired to the sensor.

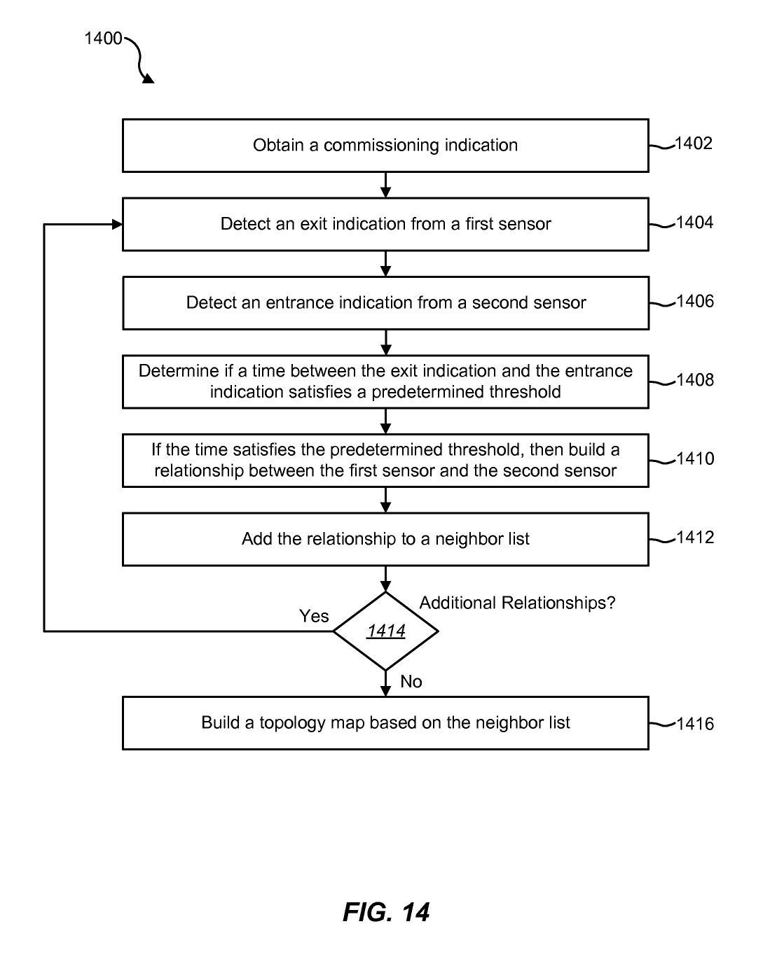

FIG. 14 is a flow diagram illustrating one example of a method 1400 for building a topology map of the sensors 102. The method 1400 may be implemented by the sensor of FIG. 1, 4, 5, or 10. In particular, the method 1400 may be implemented by the commissioning module 104 of FIG. 1 or 2

At step 1402, a commissioning indication may be obtained. At step 1404, an exit indication may be detected from a first sensor. In one configuration, the exit indication may be a detection by the sensor 102 that an occupant exited the field of view of the sensor 102. In another configuration, an exit indication may be a news broadcast by another sensor indicating that an occupant exited the field of view a sensor. At step 1406, an entrance indication from a second sensor may be detected. In one configuration, the entrance indication may be a detection by the sensor 102 than an occupant entered the field of view of the sensor 102. In another configuration, an entrance indication may be a news broadcast by another sensor indicating that an occupant entered the field of view of the second sensor.

At step 1408, it may be determined if a time between the exit indication and the entrance indication satisfies a predetermined threshold. At step 1410, if the time satisfies the predetermined threshold, then a relationship between the first sensor and the second sensor may be built. In one configuration, the relationship may indicate a location inside the field of view of a first sensor that is related to a location that is inside the view of the second sensor. Thus, specific doorways in the field of view of a first sensor may be paired with specific doorways in the field of view of a second sensor. At step 1412, the relationship may be added to a neighbor list.

At step 1414, a determination may be made as to whether there are additional relationships. If there are additional relationships, then the method returns to step 1404. In one configuration, the existence of additional relationships may be based on if there are no new doorway indications. In another configuration, the existence of additional relationships may be based on if the occupant is no longer passing through any doorways (the occupant has traveled through every doorway and has exited the building, for example). If it is determined that there are no additional relationships, then the method continues to step 1416. At step 1416, a topology map may be built based on the neighbor list. For example, the relationships between a first sensor and a second sensor may be combined to create a topological map.

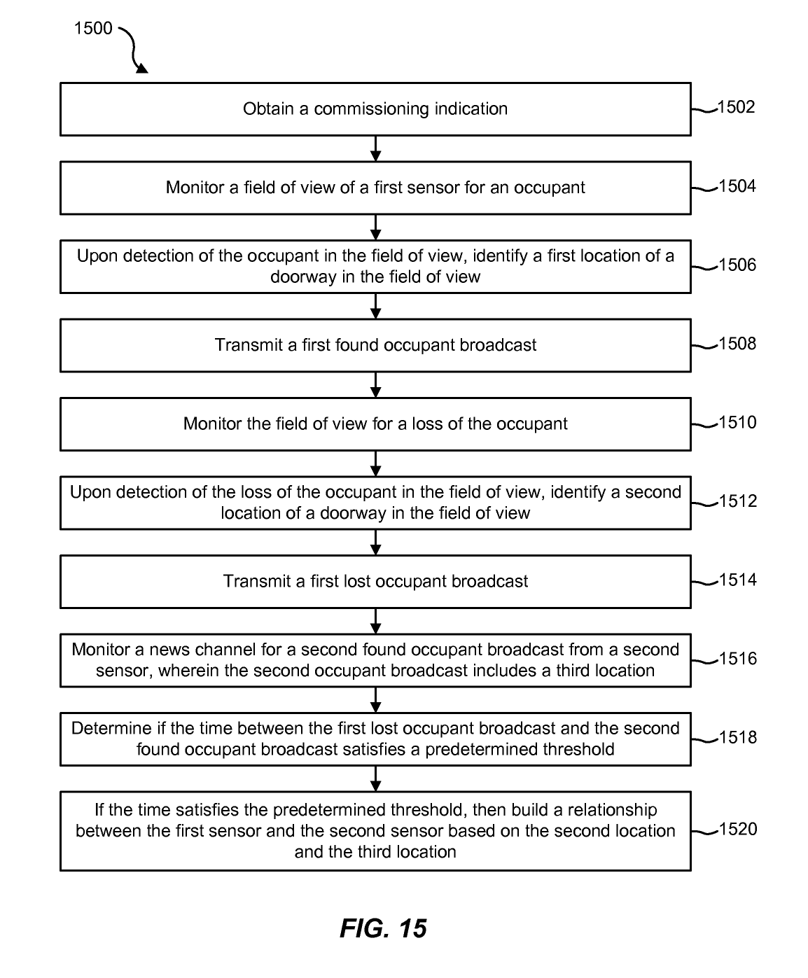

FIG. 15 is a flow diagram illustrating one example of a method 1500 for building relationships between sensors 102. The method 1500 may be implemented by the sensor of FIG. 1, 4, 5, or 10. In particular, the method 1500 may be implemented by the commissioning module 104 of FIG. 1 or 2

At step 1502, a commissioning indication may be obtained. At step 1504, a field of view of a first sensor may be monitored for an occupant. Upon detection of the occupant in the field of view, at step 1506, a first location of a doorway may be identified in the field of view. For example, the first sensor may identify the location where the occupant entered the field of view. At step 1508, a first found occupant broadcast may be transmitted. For example, the first sensor may communicate and transmit a broadcast indicating that a first occupant has been found. At step 1510, the field of view may be monitored for a loss of the occupant. Upon detection of the loss of the occupant in the field of view, at step 1512, a second location of a doorway may be identified in the field of view. For example, the location where the occupant exited the field of view may be identified as the location of a doorway in the field of view. At step 1514, a first lost occupant broadcast may be transmitted.

At step 1516, a news channel may be monitored for a second found occupant broadcast from a second sensor. In some configurations, the second found occupant broadcast may include a third location. At step 1518, it may be determined if the time between the first lost occupant broadcast and the second found occupant broadcast satisfies a predetermined threshold. At step 1520, if the time satisfies the predetermined threshold, then a relationship between the first sensor and the second sensor may be built based on the second location and the third location.

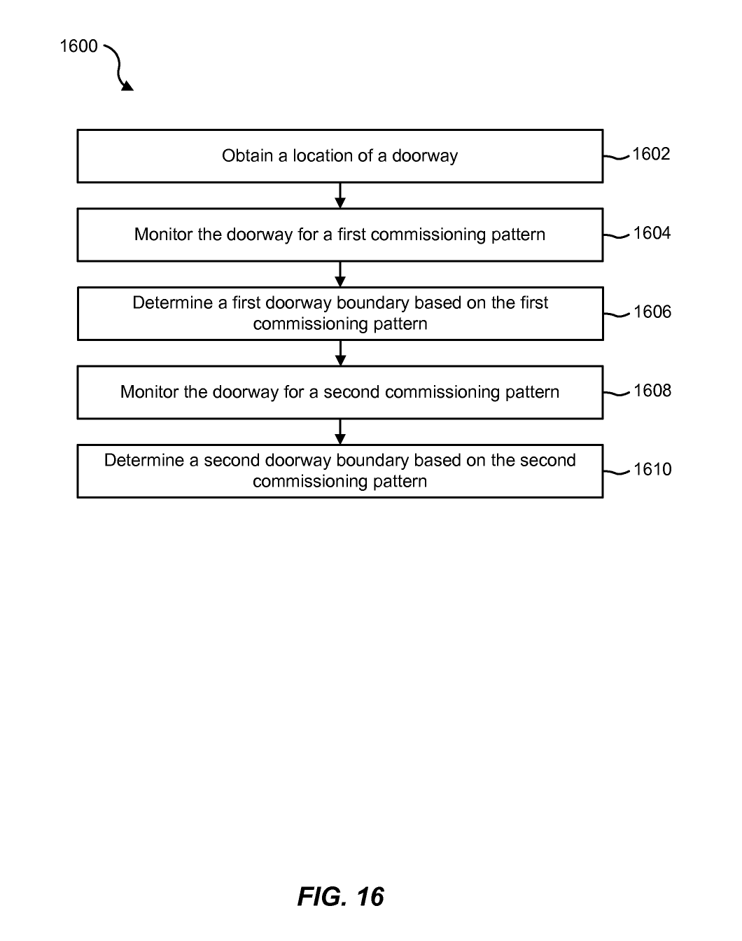

FIG. 16 is a flow diagram illustrating one example of a method 1600 for training a doorway boundary. The method 1600 may be implemented by the sensor of FIG. 1, 4, 5, or 10. In particular, the method 1600 may be implemented by the commissioning module 104 of FIG. 1 or 2

At step 1602, a location of a doorway may be obtained. For example, the location of the doorway may correspond to the location identified in the relationship mapping process. At step 1604, the doorway may be monitored for a first commissioning pattern. At step 1606, a first doorway boundary may be determined based on the first commissioning pattern. For example, the sensor 102 may perform intelligent algorithms to determine a boundary based on the first commissioning pattern. At step 1608, the doorway may be monitored for a second commissioning pattern. At step 1610, a second doorway boundary may be determined based on the second commissioning pattern.

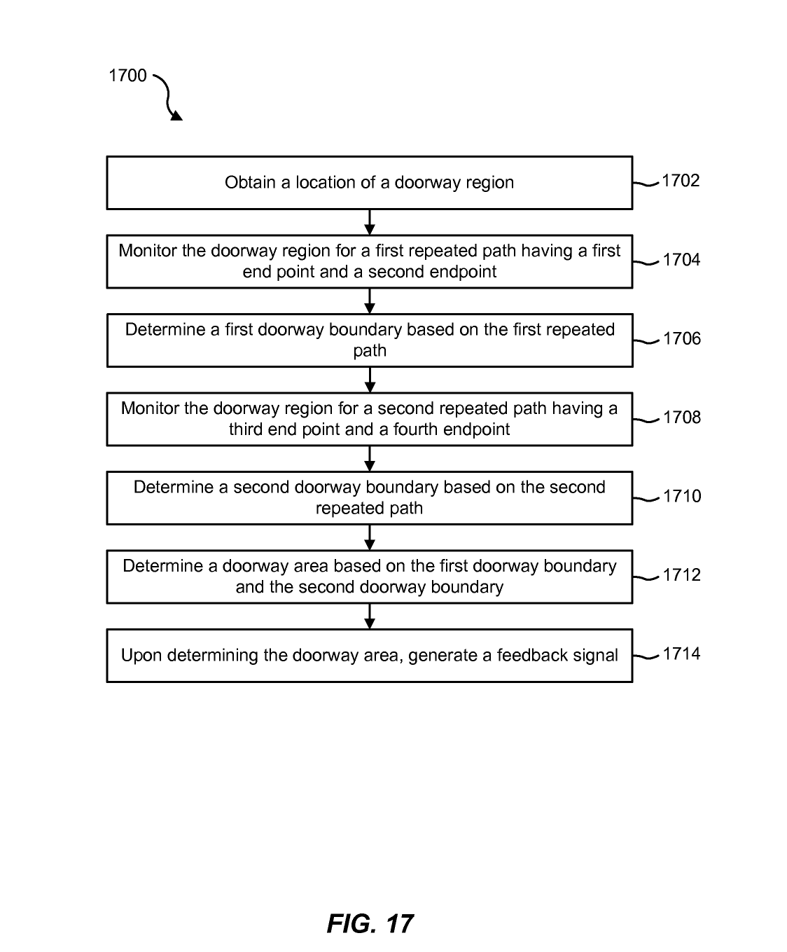

FIG. 17 is a flow diagram illustrating another example of a method 1700 for training a doorway boundary. The method 1700 may be implemented by the sensor of FIG. 1, 4, 5, or 10. In particular, the method 1700 may be implemented by the commissioning module 104 of FIG. 1 or 2

At step 1702, a location of the doorway region may be obtained. At step 1704, the doorway region may be monitored for a first repeated path having a first end point and a second end point. For example, the path may be repeated between the first end point and the second end point. At step 1706, a first doorway boundary may be determined based on the first repeated path.

At step 1708, the doorway region may be monitored for a second repeated path having a third end point and a fourth end point. At step 1710, a second doorway boundary may be determined based on the second repeated path.

At step 1712, a doorway area may be determined based on the first doorway boundary and the second doorway boundary. For example, the doorway area may be determined based on the bounded area from the first doorway boundary and the second doorway boundary. Upon determining the doorway area, at step 1714, a feedback signal may be generated.

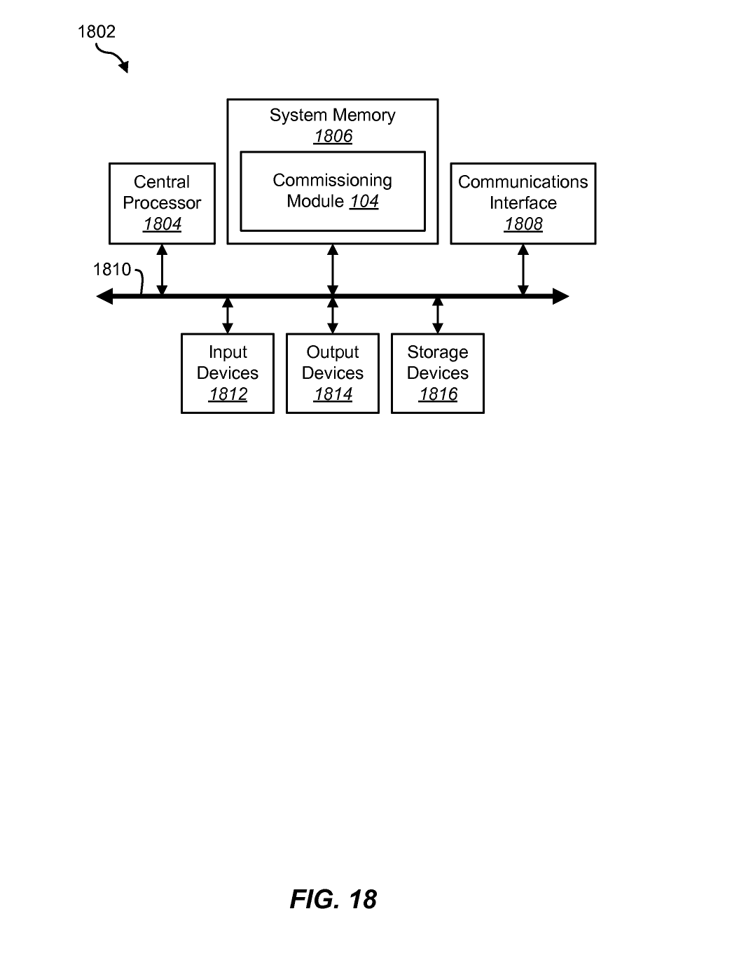

FIG. 18 depicts a block diagram of an electronic device 1802 suitable for implementing the present systems and methods. The electronic device 1802 includes a bus 1810 which interconnects major subsystems of computer system 1802, such as a central processor 1804, a system memory 1806 (typically RAM, but which may also include ROM, flash RAM, or the like), a communications interface 1808, input devices 1812, output device 1814, and storage devices 1816 (hard disk, floppy disk, optical disk, etc.).

Bus 1810 allows data communication between central processor 1804 and system memory 1806, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the commissioning module 104 to implement the present systems and methods may be stored within the system memory 1806. The commissioning module 104 may be an example of the commissioning module of FIG. 1 or 2. Applications and/or algorithms resident with the electronic device 1802 are generally stored on and accessed via a non-transitory computer readable medium (stored in the system memory 1806, for example), such as a hard disk drive, an optical drive, a floppy disk unit, or other storage medium. Additionally, applications can be in the form of electronic signals modulated in accordance with the application and data communication technology when accessed via the communications interface 1808

Communications interface 1808 may provide a direct connection to a remote server or to the Internet via an internet service provider (ISP). Communications interface 1808 may provide a direct connection to a remote server via a direct network link to the Internet via a POP (point of presence). Communications interface 1808 may provide such connection using wireless techniques, including digital cellular telephone connection, Cellular Digital Packet Data (CDPD) connection, digital satellite data connection, or the like.

Many other devices or subsystems (not shown) may be connected in a similar manner. Conversely, all of the devices shown in FIG. 18 need not be present to practice the present systems and methods. The devices and subsystems can be interconnected in different ways from that shown in FIG. 18. The operation of an electronic device such as that shown in FIG. 18 is readily known in the art and is not discussed in detail in this application. Code to implement the present disclosure can be stored in a non-transitory computer-readable medium such as one or more of system memory 1806 and the storage devices 1816.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional electronic devices, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in an electronic device. In some embodiments, these software modules may configure an electronic device to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer implemented method for commissioning a sensor, comprising:
monitoring for a commissioning event;
upon detection of the commissioning event, pairing a switch with a sensor;
identifying a doorway that is in a field of view of the sensor; and
identifying a boundary that separates a doorway area from a neighboring area that is in the field of view of the sensor.

2. The method of claim 1, further comprising:
identifying a neighboring sensor that is associated with the neighboring area.

3. A computer implemented method for pairing a switch with a sensor, comprising:
monitoring for a synchronization event;
upon detection of the synchronization event, determining a commissioning order;
monitoring for a commissioning turn based on the commissioning order; and
upon detection of the commissioning turn, pairing a switch with a sensor.

4. The method of claim 3, wherein pairing a switch with a sensor comprises:
broadcasting a request to a plurality of switches for each switch to respond with a switch identifier; and
receiving at least one switch identifier from at least one of the plurality of switches.

5. The method of claim 3, wherein pairing a switch with a sensor comprises:
generating a list of switch identifiers, wherein each switch identifier identifies a switch;
selecting a switch identifier from the list to obtain a selected switch;
sending a command to the selected switch to turn on a light on;
determining, by a sensor, a brightness change associated with the selected switch;
sending a command to the selected switch to turn the light off;
determining a switch with the maximum brightness change; and
pairing the switch with the maximum brightness change to the sensor.

6. A computer implemented method for building a sensor relationship, comprising
obtaining a commissioning indication;
detecting an exit indication from a first sensor;
detecting an entrance indication from a second sensor;
determining if a time between the exit indication and the entrance indication satisfies a predetermined threshold; and
upon determining that the time satisfies the predetermined threshold, building a relationship between the first sensor and the second sensor.

7. The method of claim 6, further comprising:
adding the relationship to a neighbor list; and
building a topology map based on the neighbor list.

8. The method of claim 6, further comprising:
monitoring a field of view of a first sensor for an occupant;
upon detection of the occupant in the field of view, identifying a first location of a doorway in the field of view; and
transmitting a first found occupant broadcast.

9. The method of claim 6, further comprising:
monitoring the field of view for a loss of the occupant;
upon detection of the loss of the occupant in the field of view, identifying a second location of a doorway in the field of view; and
transmitting a first lost occupant broadcast.

10. The method of claim 9, further comprising:
monitoring a news channel for a second found occupant broadcast from a second sensor, wherein the second occupant broadcast includes a third location.

11. The method of claim 10, wherein the relationship is based on the second location and the third location.

12. A computer implemented method for determining a doorway boundary, comprising:
obtaining a location of a doorway;
monitoring the doorway for a first commissioning pattern; and
determining a first doorway boundary based on the first commissioning pattern.

13. The method of claim 12, further comprising:
monitoring the doorway for a second commissioning pattern; and
determining a second doorway boundary based on the second commissioning pattern.

14. The method of claim 12, wherein the first commissioning pattern comprises a first repeated path having a first endpoint and a second endpoint.

15. The method of claim 14, wherein the second commissioning pattern comprises a second repeated path having a third endpoint and a fourth endpoint.

16. The method of claim 12, further comprising:
generating a feedback signal.
